(19) United States
(12) Patent Application Publication
(10) Pub. No.: US 2014/0265867 A1
(43) Pub. Date: Sep. 18, 2014

(54) SMART LIGHT EMITTING DIODE DRIVING APPARATUS

(71) Applicant: HERGY LIGHTING TECHNOLOGY CORP., Taipei City (TW)

(72) Inventors: Cheng-Jen LEE, Taipei City (TW); Tsung-Chang CHIU, Taipei City (TW); Chun-Hung LU, Taipei City (TW)

(73) Assignee: Hergy Lighting Technology Corp., Taipei City (TW)

(21) Appl. No.: 13/831,359

(22) Filed: Mar. 14, 2013

(51) Int. Cl. H05B 33/08

(52) U.S. Cl. CPC H05B 33/0854
USPC 315/151

(57) ABSTRACT

A smart light emitting diode driving apparatus includes a micro processing unit and a light emitting diode driving circuit. An optical detection equipment is configured to send an optics characteristic signal to a computer after an optics characteristic of a light emitting diode is detected by the optical detection equipment. The computer is configured to send a control signal to the micro processing unit after the optics characteristic signal is processed by the computer. The micro processing unit is configured to record the control signal. The micro processing unit is configured to control the light emitting diode driving circuit in accordance with the control signal. The light emitting diode driving circuit is configured to output a driving current to drive the light emitting diode.

### BACKGROUND OF THE INVENTION

1. Field of the Invention

The present invention relates to a light emitting diode driving apparatus, and especially relates to a smart light emitting diode driving apparatus.

2. Description of the Related Art

FIG. 1 shows a block diagram of the light emitting diode module of the related art. A light emitting diode module 90 includes a light emitting diode 20 and a light emitting diode driving circuit 104. The light emitting diode 20 is electrically connected to the light emitting diode driving circuit 104.

The light emitting diode driving circuit 104 is configured to drive the light emitting diode 20. The optics characteristic of the light emitting diode 20 is determined by the current outputted from the light emitting diode driving circuit 104. The optics characteristic of the light emitting diode 20 is stronger if the current outputted from the light emitting diode driving circuit 104 is greater. The light intensity of the light emitting diode 20 is weaker if the current outputted from the light emitting diode driving circuit 104 is smaller.

However, in the related art mentioned above, the hardware of the light emitting diode driving circuit 104 has to be modified if the current outputted from the light emitting diode driving circuit 104 is required to change. However, it is inconvenient to modify the hardware of the light emitting diode driving circuit 104.

Especially, the light emitting diodes 20 are classified according to the optics characteristic after the light emitting diodes 20 have been manufactured.

The hardware of some light emitting diode driving circuit 104 has to be modified if the light emitting diodes 20 having different optics characteristic is applied to the light emitting diode modules 90 which are designed to have the same optics characteristic. However, it is inconvenient to modify the hardware of the light emitting diode driving circuit 104.

Moreover, the optics characteristic of the light emitting diode 20 is weaker if the usage time of the light emitting diode 20 is longer. However, the hardware of the light emitting diode driving circuit 104 mounted on a printed circuit board (not shown in FIG. 1) is not possible to be modified to change the current output from the light emitting diode driving circuit 104. Therefore, it is unavoidable that the light intensity of the light emitting diode 20 is weaker if the usage time of the light emitting diode 20 is longer.

### SUMMARY OF THE INVENTION

In order to solve the above-mentioned problems, an object of the present invention is to provide a smart light emitting diode driving apparatus.

In order to achieve the object of the present invention mentioned above, the smart light emitting diode driving apparatus is applied to a light emitting diode, an optical detection equipment, and a computer. The optical detection equipment is electrically connected to the computer. The smart light emitting diode driving apparatus includes a micro processing unit and a light emitting diode driving circuit. The micro processing unit is electrically connected to the computer. The light emitting diode driving circuit is electrically connected to the micro processing unit and the light emitting diode. The optical detection equipment is configured to send an optics characteristic signal to the computer after an optics characteristic of the light emitting diode is detected by the optical detection equipment. The computer is configured to send a control signal to the micro processing unit after the optics characteristic signal is processed by the computer. The micro processing unit is configured to record the control signal. The micro processing unit is configured to control the light emitting diode driving circuit in accordance with the control signal. The light emitting diode driving circuit is configured to output a driving current to drive the light emitting diode.

### BRIEF DESCRIPTION OF DRAWING

FIG. 1 shows a block diagram of the light emitting diode module of the related art.

FIG. 2 shows a block diagram of the smart light emitting diode driving apparatus of the present invention.

FIG. 3 shows a block diagram of the smart light emitting diode module of the present invention.

FIG. 4 shows a block diagram of the smart light emitting diode system of the present invention.

### DETAILED DESCRIPTION OF THE INVENTION

FIG. 2 shows a block diagram of the smart light emitting diode driving apparatus of the present invention. A smart light emitting diode driving apparatus 10 is applied to a light emitting diode 20, an optical detection equipment 30, and a computer 40.

FIG. 3 shows a block diagram of the smart light emitting diode module of the present invention. The light emitting diode 20 and the smart light emitting diode driving apparatus 10 are integrated into a smart light emitting diode module 70.

FIG. 4 shows a block diagram of the smart light emitting diode system of the present invention. The smart light emitting diode module 70, the optical detection equipment 30, and the computer 40 are integrated into a smart light emitting diode system 80.

The smart light emitting diode driving apparatus 10 includes a micro processing unit 102, a light emitting diode driving circuit 104, a timing unit 106, a temperature sensing unit 108, a memory unit 110, a digital multiplexed interface 112, and a digital addressable lighting interface 114.

The optical detection equipment 30 is electrically connected to the computer 40. The micro processing unit 102 is electrically connected to the computer 40, the light emitting diode driving circuit 104, the timing unit 106, the temperature sensing unit 108, the memory unit 110, the digital multiplexed interface 112, and the digital addressable lighting interface 114. The light emitting diode 20 is electrically connected to the light emitting diode driving circuit 104 and the timing unit 106.

The optical detection equipment 30 is configured to send an optics characteristic signal 50 to the computer 40 after an optics characteristic of the light emitting diode 20 is detected by the optical detection equipment 30. The computer 40 is configured to send a control signal 60 to the micro processing unit 102 after the optics characteristic signal 50 is processed by the computer 40. The micro processing unit 102 is configured to record the control signal 60. The micro processing unit 102 is configured to control the light emitting diode driving circuit 104 in accordance with the control signal 60. The light emitting diode driving circuit 104 is configured to output a driving current 116 to drive the light emitting diode 20.

As mentioned in the related art, the light emitting diodes 20 are classified according to the optics characteristic after the light emitting diodes 20 have been manufactured.

Therefore, the computer 40 is informed by the optical detection equipment 30 after the optics characteristic of the light emitting diode 20 is detected by the optical detection equipment 30. The micro processing unit 102 is informed by the computer 40 after the optics characteristic signal 50 is processed by the computer 40. Then, the optics characteristic of the light emitting diode 20 is recorded by the micro processing unit 102.

Therefore, the light emitting diode driving circuit 104 is controlled by the micro processing unit 102 in accordance with the control signal 60 to drive the light emitting diode 20 when the smart light emitting diode module 70 is mounted on a printed circuit board (not shown in FIG. 2-4). Moreover, the computer 40 and the micro processing unit 102 are configured to set and process the data of the required light intensity, the optics characteristic, the outputted current, and so on.

Therefore, none of the hardware of the light emitting diode driving circuits 104 have to be modified even if the light emitting diodes 20 having different optics characteristic are applied to the smart light emitting diode modules 70 which are designed to have the same optics characteristic. It is convenient.

Moreover, the timing unit 106 is configured to count the usage time of the light emitting diode 20. The micro processing unit 102 is configured to accumulate the usage time of the light emitting diode 20. The light emitting diode 20 is driven by the light emitting diode driving circuit 104 with a first predetermined current 118 when the total usage time of the light emitting diode 20 is over a first predetermined time. The first predetermined current 118 is greater than the driving current 116.

For example, the driving current 116 is 500 mA. The light emitting diode 20 is driven by the light emitting diode driving circuit 104 with a 520 mA current when the total usage time of the light emitting diode 20 is over 1000 hours. The light emitting diode 20 is driven by the light emitting diode driving circuit 104 with a 550 mA current when the total usage time of the light emitting diode 20 is over 5000 hours. The light emitting diode 20 is driven by the light emitting diode driving circuit 104 with a 570 mA current when the total usage time of the light emitting diode 20 is over 10000 hours. Therefore, the optics characteristic of the light emitting diode 20 is stable even if the total usage time of the light emitting diode 20 is very long.

Moreover, the temperature sensing unit 108 is configured to sense the temperatures of the light emitting diode 20. The light emitting diode 20 is driven by the light emitting diode driving circuit 104 with a second predetermined current 120 (for example, 450 mA) when the temperature of the light emitting diode 20 is over a predetermined temperature (for example, 85 degrees Celsius). The second predetermined current 120 (for example, 450 mA) is smaller than the driving current 116 (for example, 500 mA). The light emitting diode driving circuit 104 is configured to stop driving the light emitting diode 20 if the temperature of the light emitting diode 20 is too high (for example, 100 degrees Celsius).

The micro processing unit 102 is, for example but not limited to, a microprocessor. The timing unit 106 is, for example but not limited to, a timer. The temperature sensing unit 108 is, for example but not limited to, a temperature sensor. The memory unit 110 is, for example but not limited to, a memory.

The features of the present invention are as following. The optical detection equipment 30 is configured to send the optics characteristic signal 50 to the computer 40 after the optics characteristic of the light emitting diode 20 is detected by the optical detection equipment 30. The computer 40 is configured to send the control signal 60 to the micro processing unit 102 after the optics characteristic signal 50 is processed by the computer 40. The micro processing unit 102 is configured to record the control signal 60. The micro processing unit 102 is configured to control the light emitting diode driving circuit 104 in accordance with the control signal 60. The light emitting diode driving circuit 104 is configured to output the driving current 116 to drive the light emitting diode 20.

Therefore, none of the hardware of the light emitting diode driving circuits 104 have to be modified even if the light emitting diodes 20 having different optics characteristic are applied to the smart light emitting diode modules 70 which are designed to have the same optics characteristic. Moreover, the optics characteristic of the light emitting diode 20 is stable even if the total usage time of the light emitting diode 20 is very long. The present invention is configured to protect the light emitting diode 20 from overheating.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A smart light emitting diode driving apparatus applied to a light emitting diode, an optical detection equipment, and a computer electrically connected to the optical detection equipment, the smart light emitting diode driving apparatus including:
a micro processing unit electrically connected to the computer; and
a light emitting diode driving circuit electrically connected to the micro processing unit and the light emitting diode,
wherein the optical detection equipment is configured to send an optics characteristic signal to the computer after an optics characteristic of the light emitting diode is detected by the optical detection equipment; the computer is configured to send a control signal to the micro processing unit after the optics characteristic signal is processed by the computer; the micro processing unit is configured to record the control signal; the micro processing unit is configured to control the light emitting diode driving circuit in accordance with the control signal; the light emitting diode driving circuit is configured to output a driving current to drive the light emitting diode.

2. The smart light emitting diode driving apparatus in claim 1, further including:
a timing unit electrically connected to the micro processing unit and the light emitting diode, the timing unit configured to count a usage time of the light emitting diode,
wherein the micro processing unit is configured to accumulate the usage time of the light emitting diode; the light emitting diode is driven by the light emitting diode driving circuit with a first predetermined current when total usage time of the light emitting diode is over a first predetermined time; the first predetermined current is greater than the driving current.

3. The smart light emitting diode driving apparatus in claim 2, further including:
a temperature sensing unit electrically connected to the micro processing unit, the temperature sensing unit configured to sense temperatures of the light emitting diode,
wherein the light emitting diode is driven by the light emitting diode driving circuit with a second predetermined current when the temperature of the light emitting diode is over a predetermined temperature; the second predetermined current is smaller than the driving current.

4. The smart light emitting diode driving apparatus in claim 3, further including:
a memory unit electrically connected to the micro processing unit.

5. The smart light emitting diode driving apparatus in claim 4, further including:
a digital multiplexed interface electrically connected to the micro processing unit.

6. The smart light emitting diode driving apparatus in claim 5, further including:
a digital addressable lighting interface electrically connected to the micro processing unit.

7. The smart light emitting diode driving apparatus in claim 6, wherein the micro processing unit is a microprocessor.

8. The smart light emitting diode driving apparatus in claim 7, wherein the timing unit is a timer.

9. The smart light emitting diode driving apparatus in claim 8, wherein the temperature sensing unit is a temperature sensor.

10. The smart light emitting diode driving apparatus in claim 9, wherein the memory unit is a memory.
